(19) United States
(12) Patent Application Publication
(10) Pub. No.: US 2010/0161423 A1
(43) Pub. Date: Jun. 24, 2010

(54) MULTIMEDIA PRODUCT DISPLAY

(76) Inventor: David Nowacek, San Antonio, TX (US)

Correspondence Address: JACKSON WALKER, L.L.P., 112 E. PECAN, SUITE 2400, SAN ANTONIO, TX, 78205, US

(21) Appl. No.: 12/599,437

(22) PCT Filed: Apr. 24, 2008
(86) PCT No.: PCT/US08/05255

§ 371 Date: Nov. 9, 2009

Related U.S. Application Data
(60) Provisional application No. 60/925,996, filed on Apr. 24, 2007.

(51) Int. Cl. G06Q 30/00; H04N 7/18

(52) U.S. Cl. 705/14.65; 348/150; 348/564; 348/E07.085

(57) ABSTRACT

An multimedia product display (MPD) for advertising goods includes a display screen and a programmable display controller for providing an image to the display screen. The screen may be formed of known technologies such as LCD, TFT LCD, NST LCD, and OLED. The screen is integrated into a case that imitates the form factor of the product advertised, for example, a display that looks like a box of WHEATIES® cereal may be used to advertise WHEATIES® cereal. In other embodiments, the display screen and programmable computer may be integrated into actual product packaging, for example, a COCA-COLA FRIDGE PACK o package may include animated instructions for opening and using the pack.

### CROSS REFERENCE TO RELATED APPLICATIONS

This application claims the benefit of U.S. provisional application 60/925,996, which is incorporated herein by reference. Applicant's co-pending application entitled “Standalone Active Display Device for Advertising Goods” filed on Apr. 24, 2008 is incorporated herein by reference.

### BACKGROUND

This specification relates to the field of retail marketing and m ore particularly to an active display for advertising goods.

Many retail products are provided in packaging that includes rigid outer walls. The packaging usually includes static labels that display trademarked logos, trademarked text, and/or other markings identifying the product, the source of the product, or both.

### BRIEF DESCRIPTION OF THE DRAWINGS

FIG. 1 is a perspective view depicting selected elements an exemplary multimedia product display (MPD);

FIG. 2 depicts selected components of an embodiment of an MPD;

FIG. 3 is a perspective view depicting selected elements of an embodiment of an MAD having a curved display screen;

FIG. 4 is a partial cross sectional view of the MPD shown in FIG. 3;

FIG. 5 is a front view of an embodiment of an MPD placed on a shelf with a number of products for sale;

FIG. 6 is a perspective view depicting products stacked on a shelf with an embodiment of an multimedia product display;

FIG. 7 is a perspective view of an embodiment of an MPD integrated into product packaging; and

FIG. 8 is a block diagram of selected elements of an embodiment of a display controller.

### SUMMARY OF THE INVENTION

In one aspect, a multimedia product display includes a display screen and a display controller for providing an image to the display screen. The display screen may be provided by known technologies such as LCD, TFT-LCD, NST, and OLED. The screen is integrated into a case that imitates or is otherwise visually and/or mechanically similar to the form factor of the product advertised. For example, a display that looks like a box of WHEATIES® cereal may be used to advertise WHEATIES® cereal. In other embodiments, the display screen and programmable computer may be integrated into actual product packaging. For example, a COCA-COLA FRIDGE PACK® package may include animated instructions for opening and using the pack.

### DETAILED DESCRIPTION OF THE EMBODIMENTS

A multimedia product display (MPD) will now be described with more particular reference to the attached drawings. Hereafter, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance or example of an element and the unhyphenated form of the reference numeral refers to the element generically or collectively. Thus, for example, widget 102-1 may refer to a “pen,” which may be an instance or example of the class of “writing implements.” Writing implements may be referred to collectively as “writing implements 102” and any one may be referred to generically as a “writing implement 102.”

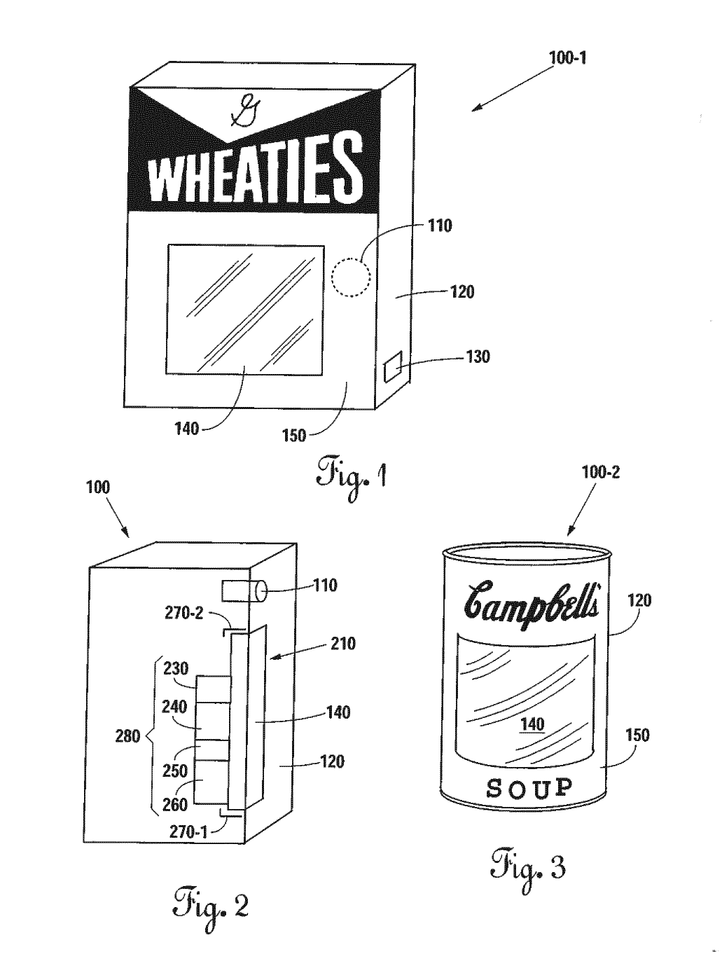

FIG. 1 is a perspective view of selected elements of an embodiment of an MPD 100. In the depicted embodiment, the MPD 100-1 takes the form of a box of WHEATIES® cereal. The MPD 100-1 as depicted may have an exterior casing 120 with dimensions substantially conforming to the dimensions of an actual box of WHEATIES® cereal, or may have dimensions different from but proportional to the dimensions of an actual box of WHEATIES® cereal. Exterior casing 120 may be constructed of the same material as an actual package for a box of WHEATIES®, or may be of a completely different material. A front surface 150 of the MPD 100-1 includes a display screen 140. Display screen 140 may employ a known display technology, which may include, as examples, liquid crystals display (LCD), thin-film transistor LCD (TFT-LCD), super-twisted nematic LCD (STN-LCD), organic light emitting diode (OLED), and interactive touch screen. MPD 100-1 as shown also includes a speaker 110. In some embodiments, display screen 140 and speaker 110 are enclosed and protected by exterior casing 120. The MPD 100-1 may also include a radio frequency identification (RFID) chip 130. Since the MPD 100-1 may be attractive for theft, the RFID chip 130 can be used with an in-store security system to prevent theft.

An MPD 100-1 as depicted in FIG. 1 may useful in providing a multimedia advertisement for the product. For example, WHEATIES® often depicts athletes on the front of its boxes to suggest that there are health and strength benefits to eating WHEATIES®. When an MPD 100-1 is used in an on-shelf display, much more than a static photograph of the athlete can be used in the advertisement. With the multimedia capabilities of MPD 100-1, in some embodiments, images of numerous athletes may be provided, and an appropriate soundtrack, such as a quote from the athlete, may be provided. The image may be changed from time to time so as to appeal to a range of athletes in different sports. In other embodiments, an entire videographic scene and accompanying soundtrack can be provided. For example, MPD 100-1 may portray video footage of a moment of athletic triumph, complete with cheering crowds. Such a rich multimedia experience may be effective in inducing positive feelings about the products in consumers' minds.

FIG. 2 depicts selected components of an embodiment of an MPD 100. In addition to the speaker 110, display screen 140, and the exterior casing 120, there are also shown components that may be used to form a display controller 280. As depicted in FIG. 2, the components of display controller 280 include a power supply 230, an embedded processor 240, memory 250, and a network interface 260. Display controller 280 may be affixed to the exterior casing by means of brackets 270.

An MPD 100 as depicted in FIG. 2 may also be communicatively coupled to a camera to capture an image of a nearby consumer, as is described in applicant's co-pending application “Standalone Active Display Device for Advertising Goods,” filed Apr. 24, 2008. An image of a consumer may be integrated into the image displayed on the display screen 140, and the consumer may be depicted interacting with the product or using it for an intended purpose.

FIG. 3 discloses another embodiment of an MPD 100-2, wherein the MPD 100-2 takes the form of a CAMPBELL' S® soup can. In this embodiment, the exterior casing 120 is substantially cylindrical in shape. In this embodiment, there is no distinctive front face to serve the role of a front surface 150 and , therefore, the role of front surface 150 may be served by the portion of the cylinder that is beneath the primary logo. Because the exterior casing 120 is curved, display screen 140 is constructed of a material that can be curved to fit the exterior casing 120. In this case, an organic light emitting diode (OLED) display may be appropriate.

FIG. 4 is a partial cross sectional top view of the MPD 100-2 of FIG. 3, FIG. 4 depicts an exemplary arrangement of various components of MPD 100-2.

FIG. 5 is a front view of a shelf arranged for advertising a product. Products for sale 510 and an MPD 100-5 are arranged in a line on the shelf. In this embodiment, a form factor of the MPD 100-5 is the same as or similar to the form factor of the products for sale 510 or the packaging for the products for sale. As depicted in FIG. 5, the MPD 100-5 is placed at the end of the display. In this embodiment, the MPD 100-5 blends in with the products for sale 510, and may even appear to be a product for sale to a casual observer. On closer inspection, however, the observer will distinguish MPD 100-5 from the products for sale 510 and, in at least some embodiments, the observer will be able to view multimedia content displayed by MPD 100-5.

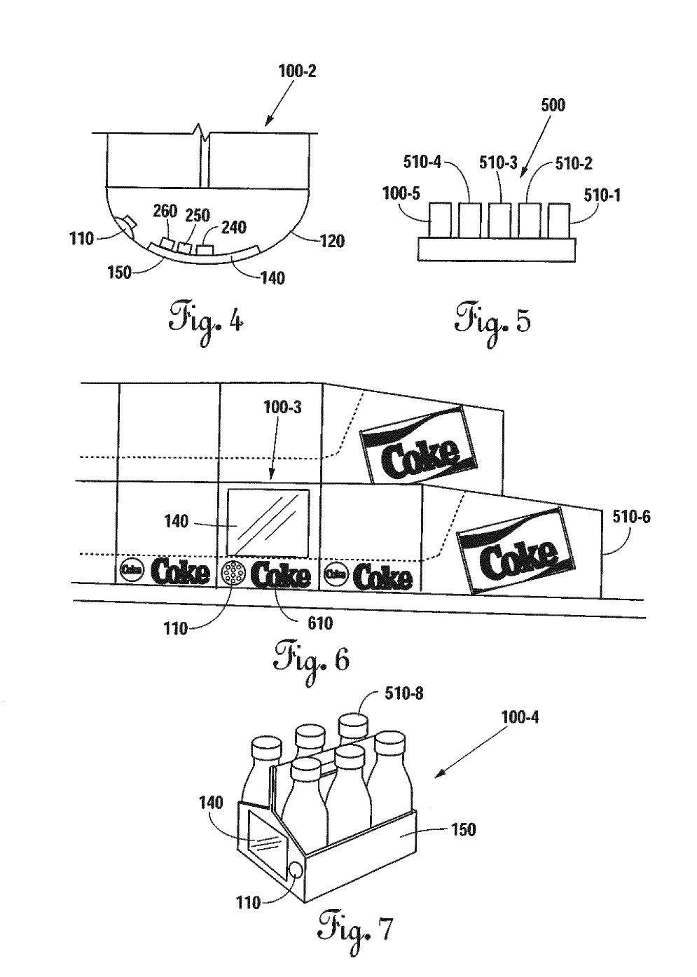

FIG. 6 is a perspective view depicting an embodiment of an MPD 100-3 integrated with a number of COCA-COLA FRIDGE PACK® packages 510-6. The MPD 100-3 includes a display screen 140 and a speaker 110. As in the embodiment depicted in FIG. 5, the MPD 100-3 is placed to blend in with the packages 510-6, but also draws attention to them. In this embodiment, the MPD 100-3 may be equipped with a proximity sensor 610 discretely integrated into the “O” of the COKE@ logo. Thus, MPD 100-3 appears to be another package 510-6 when nobody is present, but provides a multimedia display when proximity sensor 610 detects a nearby customer. This may serve the dual purposes of conserving power and helping to draw a customer's attention.

FIG. 7 discloses an MPD 100-4 that is configured as actual packaging for a product for sale. In the depicted embodiment, a six pack of products for sale 510-8 is contained or otherwise packaged in an MPD 100-4 that forms an exterior casing 150 that defines cavities for receiving, holding, or otherwise engaging products for sale 510-8. A display screen 140 and microphone 110 are provided as components of MPD 100-4. In embodiments where the MPD 100-4 is disposable, the components of MPD 100-4 may be chosen to be inexpensive. Besides advertising, the MPD 100-4 may provide useful instructions on using the product or the package itself.

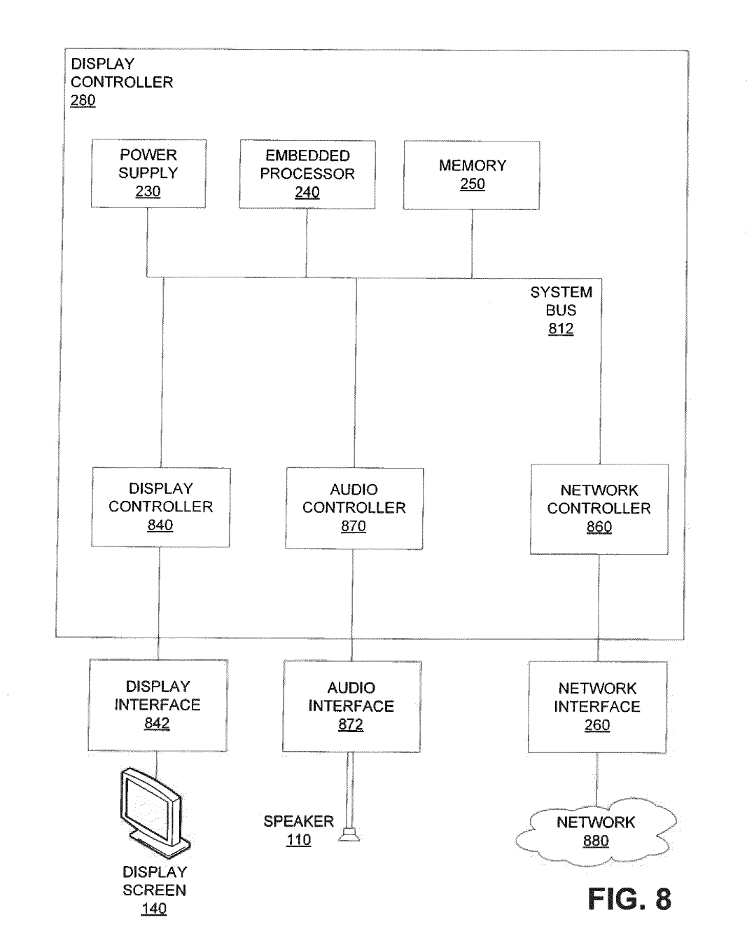

FIG. 8 is a block diagram of a display controller 280. The display controller 280 is controlled by an embedded processor 240. Embedded processor 240 connects to other parts of the system via a system bus 812. Embedded processor 240 may be any type of programmable device, including a microprocessor, a graphics processing unit (GPU), an application-specific integrated circuit (ASIC), a field-programmable gate array (FPGA), or a programmable logic array (PLA). Memory 250 may include data representing an image or series of images that are to be displayed. Memory 250 may be any memory device, such as are commonly known in the art, including one or a combination of volatile memory, e.g., random access memory (RAM) and persistent memory or storage including, e.g., flash memory, read only memory (ROM), hard disk drive (HDD) or other magnetic storage, or optical media. Based on the data in memory 250, embedded processor 240 may provide an advertising image to the display controller 840, which formats or otherwise processes the advertising image for display on display screen 140. Display controller 840 provides the formatted image to a display interface 842, which interfaces the display controller 280 to display screen 140. Display interface 842 may provide or support any number of known display protocols such as composite audio-video, composite video, component video, and high definition multimedia interface (HDMI).

The depicted embodiment of display controller also includes an audio controller 870. If an audio track is needed, memory 250 may also include data representing the audio track. The embedded processor 240 then provides the audio track to audio controller 870, which formats the audio track for speaker 110. Audio controller 870 then provides the audio track to speaker 110 through audio interface 872. A network controller 860 may be provided to allow communication through network interface 260 to network 880. Network 880 may include a computer or other device to program the display controller 280, either through a direct connection or from a remote location. In some embodiments, the network controller 860 and network interface 260 may provide or support any of a number of commonly known network interfaces, such as Ethernet, universal serial bus (USB), firewire, RS-232 serial communication, or parallel communication.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

What is claimed is:

1. A multimedia product display (MPD) for advertising a product in a product package, the display comprising:
an exterior casing having a form factor wherein a shape of the form factor of the exterior casing and a shape of a form factor of the product package are substantially the same;
a display screen occupying a part of a surface area of the exterior casing; and
a display controller communicatively coupled to the display screen and configured to provide an advertising image to the display screen.

2. The MPD of claim 1 wherein the display controller is configured to change the advertising image at intervals.

3. The MPD of claim 1 wherein a size of the exterior casing form factor and a size of the product package form factor are substantially the same.

4. The MPD of claim 1 wherein the exterior casing has a size different from and substantially proportional to the dimensions of the package for the product.

5. The MPD of claim I wherein the exterior casing and the product package are made substantially of an identical material.

6. The MPD of claim 1 wherein the MPD is further configured to provide a sound output suitable for reception by a speaker communicatively coupled to the display controller.

7. The MPD of claim 6 wherein the advertising image is a video.

8. The MPD of claim 7 wherein the display controller is configured to provide the audio output synchronized with the dynamic image.

9. The MPD of claim 1 wherein the display controller is configured to receive an image of a consumer standing near the MPD from a camera communicatively coupled to the display controller.

10. The MPD of claim 9 wherein the display controller is further configured to integrate the image of the consumer into the advertising image.

11. The MPD of claim 10 wherein the display controller is further configured to portray the consumer interacting with the advertising image.

12. The MPD of claim 11, wherein the display controller is further configured to portray the consumer interacting with the advertising image by portraying the consumer using the product for its intended purpose.

13. A method of advertising a product, the method comprising:
placing a multimedia product display (MPD) near inventory of the product, the MPD having a display screen on its surface;
enabling a processor of an advertising device having a casing to provide an advertising image for display on a display screen portion of the casing; wherein the advertising device has a form factor that substantially imitates a form factor of a package for the product.

14. A package for a product, the package comprising:
an exterior casing having an exterior surface and configured to contain the product;
a display screen occupying a portion of the exterior surface;
a memory device containing data that represents an image; and
a processor communicatively coupled to the memory device and the display screen and configured to display the image on the display screen.

15. The package of claim 14 wherein the processor is an application-specific integrated circuit.

16. The package of claim 14 wherein the memory device is selected from the group consisting of a read-only memory and a flash memory.

17. The package of claim 14 wherein the image is dynamic.

18. The package of claim 17 wherein the dynamic image portrays using the product.

19. The package of claim 17 wherein the dynamic image portrays a method of using the package.
